(19) United States
(12) Patent Application Publication
(10) Pub. No.: US 2009/0046708 A1
(43) Pub. Date: Feb. 19, 2009

(54) Methods And Systems For Transmitting A Data Attribute From An Authenticated System

(76) Inventor: Jason David Koziol, Naperville, IL (US)

Correspondence Address: MANISHA CHAKRABARTI, 3108 S. RT. 59, STE. 124-282, NAPERVILLE, IL, 60564, US

(21) Appl. No.: 11/838,210

(22) Filed: Aug. 13, 2007

(51) Int. Cl. H04L 12/50

(52) U.S. Cl. 370/360

(57) ABSTRACT

A database operable to store at least one digital signature is provided. The database is communicatively coupled to a first system. A first digital signature associated with a data string is received from a second system at the first system. A determination is made regarding whether the first digital signature matches one of the at least one digital signatures. A data attribute associated with the data string is transmitted from the first system to the second system based on the determination. First system authentication data authenticating the first system as the source of the data attribute is provided.

### CROSS-REFERENCES TO RELATED APPLICATIONS

This application is related to U.S. patent application Ser. No. 11/697,293, filed Apr. 5, 2007, entitled “METHODS AND SYSTEMS FOR GENERATING A SYMBOL IDENTIFICATION CHALLENGE” and U.S. patent application Ser. No. 11/612,470, filed Dec. 18, 2006, entitled “METHODS AND SYSTEMS FOR GENERATING A SYMBOL IDENTIFICATION CHALLENGE FOR AN AUTOMATED AGENT.” Each of the listed U.S. Patent Applications lists Jason Koziol as the inventor and is hereby incorporated by reference herein.

### FIELD OF THE INVENTION

The present invention generally relates to data security and more particularly to methods and systems for transmitting a data attribute from an authenticated system.

### BACKGROUND OF THE INVENTION

Connectivity to the Internet often exposes computers systems to malicious autonomous software applications such as for example, including but not limited, to computer viruses and worms. Such malicious software applications often infiltrate computer systems and corrupt programs or processes stored on the computer systems. Evaluation systems are often used to periodically evaluate the processes stored on a computer system to determine whether any of the stored processes have been corrupted by malicious autonomous software applications.

Such evaluation systems are often remotely located with respect to the computer systems. The evaluation system typically establishes communicative coupling with a computer system via the Internet during the evaluation. The evaluation system retrieves digital signatures of the processes stored at the computer system and compares the retrieved digital signatures against digital signatures stored at the evaluation system to determine whether any of the processes associated with the retrieved digital signatures have been corrupted.

The evaluation system typically transmits a process integrity status to the computer system regarding whether any of the stored processes have been detected as corrupted. The process integrity status is typically transmitted from the evaluation system to the computer system via the Internet. During the transmission process, the process integrity status transmission is susceptible to interception and corruption by automated agents. Examples of such automated agents include, but are not limited to, spiders, crawlers, bots, viruses, Trojans, worms or other malware. In some cases, an automated agent may intercept a process integrity status during transmission from the evaluation system to a computer system, alter the contents of the transmission, and retransmit the transmission to the computer system. For example, a process integrity status that indicates that a process stored on a computer system has been corrupted may be intercepted by an automated agent, altered to incorrectly indicate that the process is uncorrupted, and transmit the altered transmission to the computer system.

### SUMMARY OF THE INVENTION

One aspect of the invention is directed to a method of transmitting a data attribute associated with a data string from an authenticated system. A database operable to store at least one digital signature is provided. The database is communicatively coupled to a first system. A first digital signature associated with a data string is received from a second system at the first system. A determination is made regarding whether the first digital signature matches one of the at least one digital signatures. A data attribute associated with the data string is transmitted from the first system to the second system based on the determination. First system authentication data is transmitted from the first system to the second system.

Another aspect of the invention is directed to a computer readable medium for a computer executable program for transmitting a data attribute associated with a data string from an authenticated system. The computer readable medium includes computer readable code for providing a database operable to store at least one digital signature where the database is communicatively coupled to a first system, computer readable code for receiving a first digital signature associated with a data string from a second system at the first system, computer readable code for determining whether the first digital signature matches one of the at least one digital signatures, computer readable code for transmitting a data attribute associated with the data string from the first system to the second system based on the determination, and computer readable code for transmitting first system authentication data from the first system to the second system.

Another aspect of the invention is directed to a method of transmitting a data attribute associated with a data string. A database operable to store at least one digital signature is provided. The database is communicatively coupled to a first system. A first digital signature associated with a data string is received from a second system at the first system. A determination is made whether the first digital signature matches one of the at least one digital signatures. A data attribute associated with the data string is transmitted from the first system to the second system in an automated agent identification challenge format based on the determination.

Another aspect of the invention is directed to computer readable medium for storing a computer executable program for transmitting a data attribute associated with a data string. The computer readable medium includes computer readable code for providing a database operable to store at least one digital signature where the database is communicatively coupled to a first system, computer readable code for receiving a first digital signature associated with a data string from a second system at the first system, computer readable code for determining whether the first digital signature matches one of the at least one digital signatures, and computer readable code for transmitting a data attribute associated with the data string from the first system to the second system in an automated agent identification challenge format based on the determination.

Another aspect of the invention is directed to a method of transmitting a data attribute associated with a data string from an authenticated system. A database operable to store at least one digital signature is provided. The first database is communicatively coupled to a first system. A first digital signature of a data string is received from a second system at the first system. A determination is made regarding whether the first digital signature matches one of the at least one digital signatures. A data attribute associated with the data string is transmitted from the first system to a third system based on the determination. First system authentication data is transmitted from the first system to the third system.

Another aspect of the invention is directed to a computer readable medium for storing a computer executable program for transmitting a data attribute associated with a data string from an authenticated system. The computer readable medium includes computer readable code for providing a database operable to store at least one digital signature where the database is coupled to a first system, computer readable code for receiving a first digital signature of a data string from a second system at the first system, computer readable code for determining whether the first digital signature matches one of the at least one digital signatures, computer readable code for transmitting a data attribute associated with the data string from the first system to a third system based on the determination, and computer readable code for transmitting first system authentication data from the first system to the third system.

### BRIEF DESCRIPTION OF THE DRAWINGS

FIG. 1 is a block diagram representation of one embodiment an evaluation system communicatively coupled to a local user system;

FIG. 2 is a flowchart representation of one embodiment of a method of evaluating a process stored at a local user system;

FIG. 3 is a flowchart representation of one embodiment of a method of transmitting a data attribute associated with a data string from an authenticated system;

FIG. 4 is a flowchart representation of one embodiment of a method of transmitting a data attribute associated with a data string from an authenticated system; and

FIG. 5 is a flowchart representation of one embodiment of a method of transmitting a data attribute associated with a data string from an authenticated system.

### DETAILED DESCRIPTION OF THE PREFERRED EMBODIMENTS

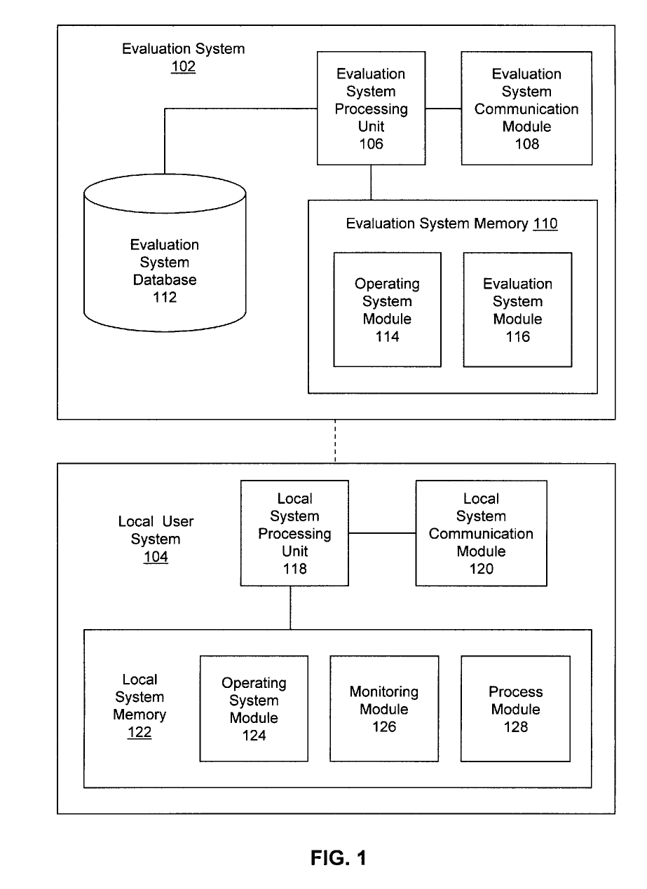

Referring to FIG. 1, a block diagram representation of one embodiment of an evaluation system 102 communicatively coupled to a local user system 104 is shown. While the evaluation system 102 is illustrated as communicatively coupled to a single local user system 104, the evaluation system 102 may be communicatively coupled to multiple local user systems 104 at a time. In one embodiment, communicative coupling is established between the evaluation system 102 and a local user system 104 on an as needed basis to perform evaluation operations with respect to that local user system 104. In one embodiment, the evaluation system 102 and the local user system 104 are integrated into a single device. In one embodiment, the evaluation system 102 and the local user system 102 are separate systems that are communicatively coupled via a network.

The evaluation system 102 generally includes an evaluation system processing unit 106 communicatively coupled to an evaluation system communication module 108, an evaluation system memory 110 and an evaluation system database 112. The evaluation system processing unit 106 generally includes a processor or controller. The evaluation system communication module 108 generally coordinates the exchange of data between the evaluation system 102 and one or more local user systems 104.

An operating system module 114 and an evaluation system module 116 are stored in the evaluation system memory 110. The evaluation system 102 generally evaluates one or more processes stored at a local user system 104. In one embodiment, the evaluation system module 116 generally evaluates one or more processes at a local user system 104 responsive to an evaluation trigger, such as for example an evaluation request, received from the local user system 104. In one embodiment, the evaluation system module 116 periodically reviews an evaluation schedule for a local user system 104 and issues an evaluation trigger, such as for example an evaluation request, to the local user system 104 based on the evaluation schedule. In one embodiment, the evaluation schedule for a local user system 104 is stored in a local user system specific data file maintained at the evaluation system 102. In one embodiment, the local system user specific data file is stored at the evaluation database 112. Alternative embodiments may include additional modules that facilitate evaluation system operations.

In one embodiment, the evaluation system memory 110 includes one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, and flash memory devices. The evaluation system processing unit 106 generally retrieves and executes machine readable instructions or software programs that are stored in the evaluation system memory 110.

In one embodiment, the evaluation system processing unit 106 is locally communicatively coupled to the evaluation system database 112. In one embodiment, the evaluation system database 112 is remotely located and the evaluation system processing unit 106 establishes communicative coupling with the evaluation system database 112 via the evaluation system communication module 108. In one embodiment, communicative coupling is established between the evaluation system processing unit 106 and the remotely located evaluation system database 112 on an as needed basis.

The evaluation system database 112 generally stores a plurality of process data files. Each process data file is associated with a specific process. In one embodiment, the process data file includes a unique process identifier and one or more process data attributes. The unique process identifier identifies a specific process. In one embodiment, the unique process identifier is a digital signature of the process. In one embodiment, the unique process identifier is hash value of the process. In one embodiment, the process attribute identifies the process as a trusted process or a whitelist process. In one embodiment, the process attribute identifies the process as an untrusted process or a blacklist process. While a number of different process data attribute have been described, examples of other process data attributes include, but are not limited to process stability, process functionality, process compatibility, process value, process popularity, or any other measurable process data attributes.

The evaluation system 102 generally evaluates one more or more processes in at different local user systems 104. A local user system 104 typically includes a local system processing unit 118 communicatively coupled to a local system communication module 120, and a local system memory 122. The local system processing unit 118 generally includes a processor or controller. The local system communication module 120 generally coordinates the exchange of data between the local user system 104 and other systems including the evaluation system 102.

An operating system module 124, a monitoring module 126, and one or more process modules 128 are stored in the local system memory 122. The monitoring module 126 generally coordinates local user system 104 evaluation operations. In one embodiment, the monitoring module 126 initiates evaluation related operations at the local user system 104 responsive to an evaluation trigger, such as for example an evaluation request, received from the evaluation system 102. In one embodiment, the monitoring module 126 initiates evaluation related operations at the local user system 104 by issuing an evaluation trigger, such as for example an evaluation request, to the evaluation system 102. Examples of processes stored at the local user system 104 include, but are not limited to, applications, drivers, daemons, or other Terminate-and-Stay-Resident (TSR) programs, batch processes, scripts, dynamically-linked library processes, codecs, kernels, memory management processes, compressors, network translators, encryptors/decryptors or other utility processes.

Alternative embodiments may include additional modules that facilitate local user system operations. In one embodiment, the local system memory 122 includes one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, and flash memory devices. The local system processing unit 118 generally retrieves and executes machine readable instructions or software programs that are stored in the local system memory 122.

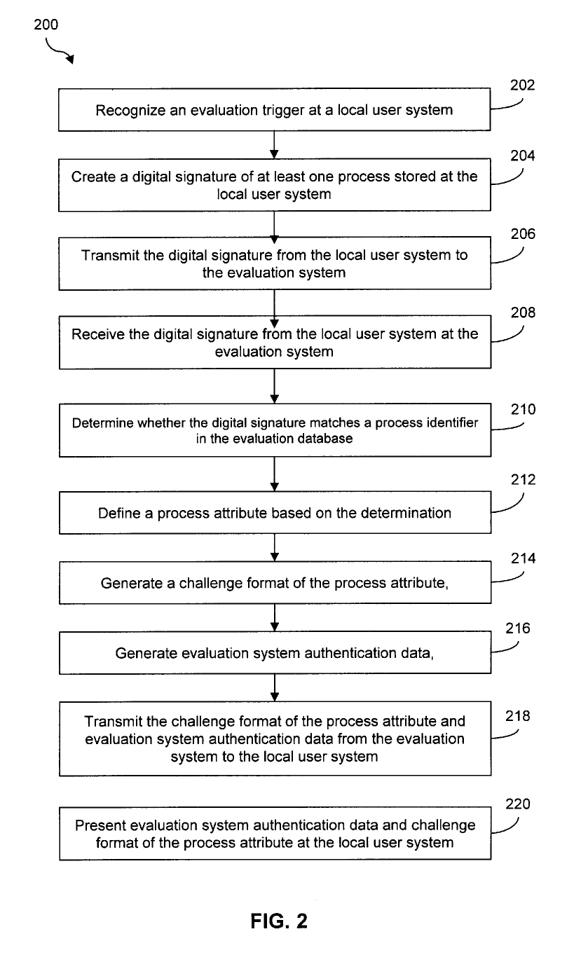

Referring to FIG. 2, a flowchart representation of one embodiment of a method 200 of evaluating a process stored at a local user system 104 is shown. An evaluation trigger is recognized by a local user system 104 at step 202. In one embodiment, the evaluation trigger is generated by the local user system 104. In one embodiment, the evaluation system 102 maintains a local user system specific evaluation schedule. The evaluation system 102 transmits an evaluation trigger to the local user system 104 in accordance with the local user system specific evaluation schedule. In one embodiment, the local user system 104 initiates an evaluation of all processes stored at the local user system 104 responsive to the evaluation trigger. In one embodiment, the local user system 104 initiates an evaluation of one or more selected processes stored at the local user system 104 responsive to the evaluation trigger.

The local user system 104 creates a digital signature of at least one of the process stored at the local user system 104 responsive to the evaluation trigger at step 204. In one embodiment, the local user system 104 generates digital signatures for selected processes stored at the local user system 104. In one embodiment, the digital signatures are generated for all the processes stored at the local user system 104. In one embodiment, digital signatures are generated for previously designated processes. In one embodiment, the digital signature is a hash value of the process.

The local user system 104 transmits the digital signatures of the at least one process to the evaluation system 102 at step 206. The evaluation system 102 receives the digital signature of the process from the local user system at step 208. In one embodiment, the evaluation system database 112 stores a process data file associated with a plurality of processes. In one embodiment, each process data file includes a unique process identifier that identifies a specific process. In one embodiment, the unique process identifier is a hash value of the process. The evaluation system 112 compares the received digital signature against the unique process identifiers stored in the evaluation system database 112 to determine whether the received digital signature matches a unique process identifier at step 210.

In one embodiment, the evaluation system database 112 stores process data files associated with trusted or whitelisted processes. If the evaluation system 102 determines that the received digital signature matches a process identifier in the evaluation system database 112, the evaluation system 102 issues a trusted process attribute at step 212. If the evaluation system 102 determines that the received digital signature does not match a process identifier in the evaluation system database 112, the evaluation system 102 issues an untrusted process attribute at step 212.

In one embodiment, the evaluation database 112 stores process data files associated with untrusted or blacklisted processes. If the evaluation system 102 determines that the received digital signature matches a process identifier in the evaluation system database 122, the evaluation system 102 issues an untrusted process attribute at step 212. If the evaluation system 102 determines that the received digital signature does not match a process identifier in the evaluation system database 112, the evaluation system 102 issues a trusted process attribute at step 212.

In one embodiment, the evaluation system database 112 stores process data files associated with both blacklisted and whitelisted processes. Each process data file includes a unique process identifier and a process attribute that identifies the process as a blacklisted process or a whitelisted process. If the evaluation system 102 determines that the received digital signature matches a process identifier in the evaluation system database 112, the evaluation system 102 retrieves the associated process attribute from the process data file at step 212.

In one embodiment, the evaluation database 112 stores process data files associated with a plurality of different processes. Each process data file includes a unique process identifier and one or more process attributes associated with the process. Examples of process attributes stored in a process data file include, but are not limited to, whitelist process attribute, blacklist process attribute, stability process attribute, functionality process attribute, compatibility process attribute, value process attribute, or any other measurable process parameter. In one embodiment, the local user system 102 issues a request for one or more specific types of process attributes associated with a transmitted digital signature of a process. If the evaluation system 102 determines that the received digital signature matches a process identifier in the evaluation system database 112, the evaluation system 102 retrieves one or more of the process attributes from the process data file in accordance with the received request from the local user system 104 at step 212.

The evaluation system 102 generates a challenge format of the one or more defined process attributes at step 214. A challenge format of a process attribute typically poses an identification challenge for an automated agent. Automated agents are typically generated by autonomous software applications that operate as an agent for a user or a program. Real and/or virtual machines are used to generate automated agents that simulate human user activity and/or behavior to search for and gain illegal access to computer systems connected to the Internet, retrieve data from the computer systems, intercept data being transmitted between systems, and generate databases of culled data for unauthorized use of the data by illegitimate users.

Automated agents typically consist of one or more sequenced operations. The sequence of operations can be executed by a real or virtual machine processor to enact the combined intent of one or more developers and/or deployers of the sequence of operations. The size of the sequence of operations associated with an automated agent can range from a single machine coded instruction to a distributed operating system running simultaneously on multiple virtual processing units. An automated agent may consist of singular agents, independent agents, an integrated system of agents, and agents composed of sub-agents where the sub-agents themselves are individual automated agents. Examples of such automated agents include, but are not limited to, viruses, Trojans, worms, bots, spiders, and crawlers.

In one embodiment, the challenge format of a process attribute is a static representation of the process attribute including one or more different noise components. For example, noise components in the form of various types of deformations and/or distortations are introduced into the static image representation of the process attribute. For example, in a Completely Automated Public Turing Test To Tell Computers And Humans Apart (CAPTCHA) challenge format of the process attribute, noise is deliberately and/or strategically integrated into the static image representation of the process attribute. In one embodiment, the challenge format representation of the process attribute is formatted to be displayed at the local user system 104 on a periodic basis.

In one embodiment, the challenge format of a process attribute is a dynamic representation of the process attribute including one or more different noise components. Examples of methods of generating dynamic representations of a symbol form of a process attribute may be found in U.S. patent application Ser. No. 11/697,293 entitled “METHODS AND SYSTEMS FOR GENERATING A SYMBOL IDENTIFICATION CHALLENGE” listing Jason Koziol as the inventor and in U.S. patent application Ser. No. 11/612,470 entitled “METHODS AND SYSTEMS FOR GENERATING A SYMBOL IDENTIFICATION CHALLENGE FOR AN AUTOMATED AGENT” listing Jason Koziol as the inventor. Each of these patent applications is hereby incorporated by reference herein.

In one embodiment, the challenge format of a process attribute is a verbal representation of the process attribute. The local user system 104 includes a speaker system and the process attribute is communicated to a user of the local user system 104 via the speaker system. In one embodiment, the challenge format of a process attribute is an animated image of a human face communicating the process attribute through mouth movement and/or facial expression. The animated image of the human face is displayed at the local user system 104. In one embodiment, the challenge format of a process attribute is an animated image of human hands communicating the process attribute through sign language. The animated human hands are displayed at the local user system 104. In one embodiment, the challenge format is a pre-defined sequence of images or symbols recognizable and understandable to humans but not easily recognizable to an automated agent.

The evaluation system 102 generates evaluation system authentication data at step 216. The evaluation system authentication data generally authenticates the source of a transmission from the evaluation system 102 as being from the evaluation system 102. In one embodiment, the evaluation system authentication data includes a timestamp. In one embodiment, when a local user system 104 receives a transmission accompanied by the evaluation system authentication data, the local user system 104 recognizes the source of the transmission as the evaluation system 102. In one embodiment, when a local user system 104 receives a transmission accompanied by the evaluation system authentication data, a user of the local user system 104 recognizes the source of the transmission as the evaluation system 102.

In one embodiment, the evaluation system authentication data is local user system specific evaluation system authentication data. In one embodiment, the local user system specific evaluation system authentication data is stored in the evaluation system database 112 and retrieved for use by the evaluation system 102 when a process attribute is transmitted from the evaluation system 102 to the local user system 104 associated with the local user system specific evaluation system authentication data.

In one embodiment, the evaluation system authentication data is generated by the evaluation system 102 and communicated to the local user system 104 prior to the performance of an evaluation of a process. In one embodiment, the evaluation system authentication data is generated by the evaluation system 102 and communicated to a user of the local user system 104 prior to the performance of an evaluation of a process. In one embodiment, a user of the local user system 104 selects the evaluation system authentication data and communicates the selected evaluation system authentication data to the evaluation system 102 prior to the performance of an evaluation of a process.

In one embodiment, the evaluation system authentication data is a personal identification number (PIN). In one embodiment, the evaluation system authentication data is a pre-defined key word or a pre-defined key phrase. In one embodiment, the evaluation system authentication data is date-time stamp, In one embodiment, the evaluation system authentication data is an originating system public key or public key infrastructure (PKI) digital signature. In one embodiment, the evaluation system authentication data is an anti-phishing image. In one embodiment, the evaluation system authentication data is a pre-defined display configuration. In one embodiment, the evaluation system authentication data is generally any symbol recognizable by the user of the local user system 104 as evaluation system authentication data.

The challenge format of the defined process attribute and the evaluation system authentication data are transmitted from the evaluation system 102 to the local user the system 104 at step 218. In one embodiment, the defined process attribute and the evaluation system authentication data are transmitted via the Internet. The local user system 104 presents the evaluation system authentication data and the received process attribute in the challenge format at the local user system 104 at step 220. In one embodiment, the evaluation system authentication data and the challenge format of the received process attribute are displayed at the local user system 104.

In one embodiment steps 204 through 220 are repeated for each process stored at the local user system 104. In one embodiment, all of the processes stored at a local user system 104 are evaluated and an aggregated process attribute is transmitted to the local user system 104 indicating that all of the stored processes are trusted processes or that least one of the stored processes is an untrusted process. In one embodiment, the untrusted processes are identified by the evaluation system 102. While the steps in the method 200 have been described in a particular order, the steps may be performed in a different order, a subset of the described steps, or additional steps may be performed in addition to the described steps without departing from the spirit of the invention.

In one embodiment of a method of evaluating a process stored at a local user system 104, steps 202 through 212 of the method 200 are performed as described above. Once the evaluation system 102 has defined a process attribute associated with the process based on a digital signature received from a local user system 104, the evaluation system 102 communicates the process attribute to a user of the local user system 104 via a user communication device. In one embodiment, the evaluation system 102 defines different types of evaluation system authentication data associated with different types of user communication devices. The user pre-arranges for the evaluation system 102 to transmit the defined process attribute and the evaluation system authentication data associated with the evaluation of a process stored on the local user system 104 via a specific user communication device using a specific communication format.

In one embodiment, the evaluation system 102 communicates the process attribute and the evaluation system authentication data to a user via a telephone communication device. Examples of evaluation system authentication data include, but are not limited to, caller identification (ID) authenticating the source of the phone call as an evaluation system call center, and pre-defined sound data. Examples of pre-defined sound data include, but are not limited to pre-defined verbal data, recognizable voice tone, a pre-defined song, a pre-defined phrase, and a pre-defined tune.

In one embodiment, the evaluation system 102 communicates the process attribute and the evaluation system authentication data to a user via a cell phone communication device. Examples of evaluation system authentication data include, but are not limited to, caller ID authenticating the source of the phone call as an evaluation system call center, and pre-defined sound data. Examples of pre-defined sound data include, but are not limited to pre-defined verbal data, recognizable voice tone, a pre-defined song, a pre-defined phrase, and a pre-defined tune.

In one embodiment, the evaluation system 102 transmits a text message including the process attribute and the evaluation system authentication data to the user cell phone. Examples of evaluation system authentication data include, but are not limited to, a personal identification number, a key word or key phrase, a date-time stamp, an originating system public key or PKI digital signature, an anti-phishing image, any symbol or sequence of symbols recognizable by the user of the local user system 104 as evaluation system authentication data.

In one embodiment, the evaluation system 102 communicates the process attribute and the evaluation system authentication data to a user via a video phone communication device. Examples of evaluation system authentication data include, but are not limited to, caller identification (ID) authenticating the source of the phone call as an evaluation system call center, and pre-defined sound data. Examples of pre-defined sound data include, but are not limited to pre-defined verbal data, recognizable voice tone, a pre-defined song, a pre-defined phrase, a pre-defined tune. Additional examples of evaluation system authentication data include, but are not limited to a personal identification number, a key word or key phrase, a date-time stamp, an originating system public key or PKI digital signature, an anti-phishing image, an image recognizable to the user, a face recognizable to the user, a dynamic representation of one or more symbols, a sequence of images, any symbol or sequence of symbols recognizable by the user of the local user system 104 as evaluation system authentication data.

In one embodiment, the evaluation system 102 communicates the process attribute and the evaluation system authentication data to a user via a facsimile communication device. Examples of evaluation system authentication data include, but are not limited to, a personal identification number, a key word or key phrase, a date-time stamp, an originating system public key or PKI digital signature, an anti-phishing image, any symbol or sequence of symbols recognizable by the user of the local user system 104 as evaluation system authentication data. While the use of a number of different user communication devices have been described, the use of alternative types of user communication devices are also considered to be within the scope of the invention.

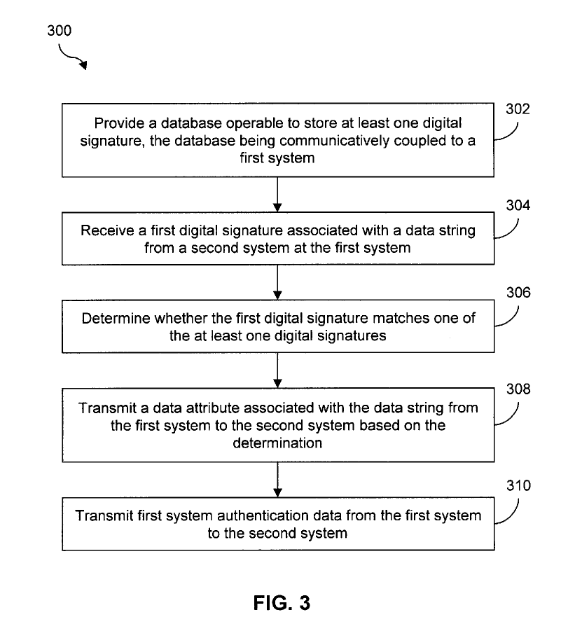

Referring to FIG. 3, a flowchart representation of one embodiment of a method 300 of transmitting a data attribute associated with a data string from an authenticated system is shown. A database operable to store at least one digital signature is provided at step 302. The database is communicatively coupled to a first system. One example of a database is an evaluation system database 112. One example of a first system is an evaluation system 102.

A first digital signature associated with a data string is received from a second system at the first system at step 304. One example of a second system is a local user system 104. One example of a data string is a process stored at the local user system 104. One example of the digital signature of the data string is a hash value of the process.

A determination is made regarding whether the first digital signature matches one of the at least one digital signatures at step 306. A data attribute associated with the data string is transmitted from the first system to the second system based on the determination at step 308. One example of a data attribute is a process attribute that identifies the data string as a trusted process or a whitelisted process. Another example of a data attribute is a process attribute that identifies the data string as an untrusted process or a blacklisted process. Other examples of data attributes include, but are not limited to process stability, process functionality, process compatibility, and process value.

First system authentication data is transmitted from the first system to the second system at step 310. Examples of first system authentication data include, but are not limited to a pin number, an anti-phishing image, a pre-defined display configuration, and a timestamp.

While the steps in the method 300 have been described in a particular order, the steps may be performed in a different order or additional steps may be performed in addition to the described steps without departing from the spirit of the invention.

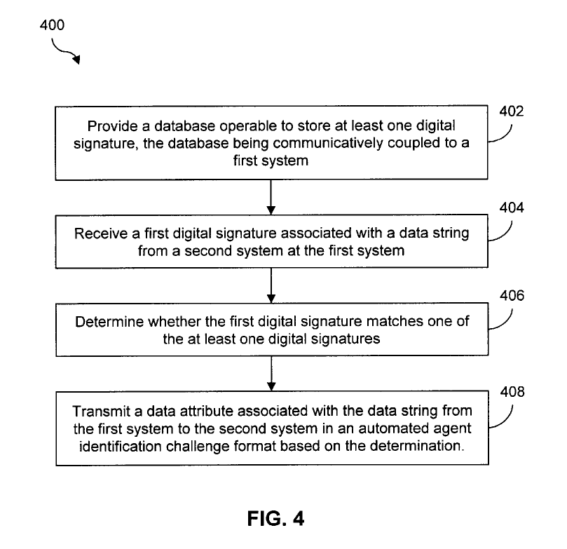

Referring to FIG. 4, a flowchart representation of one embodiment of a method 400 of transmitting a data attribute associated with a data string is shown. A database operable to store at least one digital signature is provided at step 402. The database is communicatively coupled to a first system. One example of a database is an evaluation system database 112. One example of a first system is an evaluation system 102.

A first digital signature associated with a data string is received from a second system at the first system at step 404. One example of a second system is a local user system 104. One example of a data string is a process stored at the local user system 104. One example of the digital signature of the data string is a hash value of the process.

A determination is made whether the first digital signature matches one of the at least one digital signatures at step 406. A data attribute associated with the data string is transmitted from the first system to the second system in an automated agent identification challenge format based on the determination at step 408. One example of a data attribute is a process attribute that identifies the data string as a trusted process or a whitelisted process. Another example of a data attribute is a process attribute that identifies the data string as an untrusted process or a blacklisted process. Other examples of data attributes include, but are not limited to process stability, process functionality, process compatibility, and process value. Examples of an automated agent challenge format include, but are not limited to a static CAPTCHA format and a dynamic representation including one or more different noise components.

While the steps in the method 400 have been described in a particular order, the steps may be performed in a different order or additional steps may be performed in addition to the described steps without departing from the spirit of the invention.

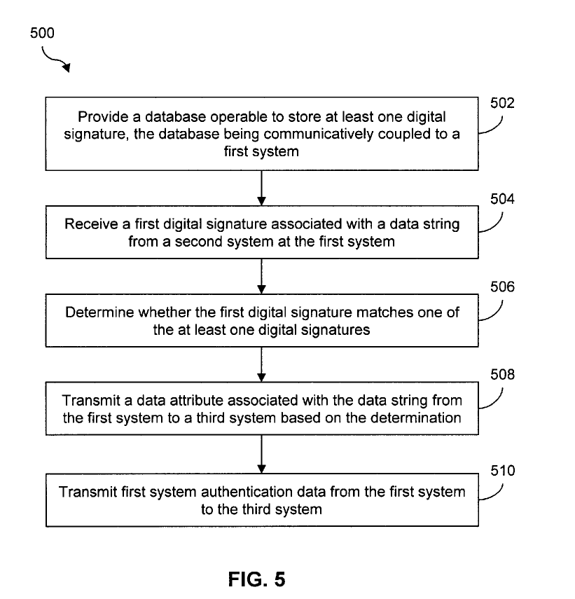

Referring to FIG. 5, a flowchart representation of a method 500 of transmitting a data attribute associated with a data string from an authenticated system is shown. A database operable to store at least one digital signature is provided at step 502. The first database is communicatively coupled to a first system. One example of a database is an evaluation system database 112. One example of a first system is an evaluation system 102.

A first digital signature of a data string is received from a second system at the first system at step 504. One example of a second system is a local user system 104. One example of a data string is a process stored at the local user system 104. One example of the digital signature of the data string is a hash value of the process.

A determination is made regarding whether the first digital signature matches one of the at least one digital signatures at step 506. A data attribute associated with the data string is transmitted from the first system to a third system based on the determination at 508. One example of a data attribute is a process attribute that identifies the data string as a trusted process or a whitelisted process. Another example of a data attribute is a process attribute that identifies the data string as an untrusted process or a blacklisted process. Other examples of data attributes include, but are not limited to process stability, process functionality, process compatibility, and process value. Examples of third systems include, but are not limited to, a telephone communication system, a cellular telephone communication system, a video telephone communication system, and a facsimile communication system.

First system authentication data is transmitted from the first system to the third system at 510. Examples of first system authentication data include, but are not limited to caller ID authenticating the source of the phone call as a first system call center, and pre-defined sound data. Examples of pre-defined sound data include, but are not limited to pre-defined verbal data, recognizable voice tone, a pre-defined song, a pre-defined phrase, a pre-defined tune. Additional examples of first system authentication data include, but are not limited to a personal identification number, a key word or key phrase, a date-time stamp, an originating system public key or PKI digital signature, an anti-phishing image, an image recognizable to the user, a face recognizable to the user, a dynamic representation of one or more symbols, a sequence of images, any symbol or sequence of symbols recognizable by the user of the local user system 104 as first system authentication data. The nature of the first system authentication data available for use is generally based on the type of the third system.

While the steps in the method 500 have been described in a particular order, the steps may be performed in a different order or additional steps may be performed in addition to the described steps without departing from the spirit of the invention.

It should be noted that while systems implemented using software or firmware executed by hardware have been described above, those having ordinary skill in the art will readily recognize that the disclosed systems could be implemented exclusively in hardware through the use of one or more custom circuits, such as for example, application-specific integrated circuits (ASICs) or any other suitable combination of hardware and/or software.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A method of transmitting a data attribute associated with a data string from an authenticated system, the method comprising:
providing a database operable to store at least one digital signature, the database being communicatively coupled to a first system;
receiving a first digital signature associated with a data string from a second system at the first system;
determining whether the first digital signature matches one of the at least one digital signatures;
transmitting a data attribute associated with the data string from the first system to the second system based on the determination; and
transmitting first system authentication data from the first system to the second system.

2. The method of claim 1, wherein transmitting first system authentication data from the first system to the second system comprises transmitting first system authentication data selected from a group consisting of a personal identification number, a pre-defined keyword, a pre-defined phrase, an anti-phishing image, a pre-defined display configuration, a date-time stamp, an first system public key or public key infrastructure digital signature.

3. The method of claim 1, wherein transmitting a data attribute associated with the data string comprises transmitting a data attribute selected from a group consisting of data whitelisted, data blacklisted, data stability, data functionality, data compatibility, and data value.

4. The method of claim 1 wherein providing a database operable to store at least one digital signature comprises providing a database operable to store at least one digital signature selected from a group consisting of a digital signature of whitelisted datastring, a digital signature of blacklisted datastring, and a hash value of the data string.

5. The method of claim 1, wherein receiving a first digital signature of a data string from a second system at the first system comprises receiving a hash value of the data string from the second system at the first system.

6. The method of claim 1, wherein transmitting a data attribute associated with the data string from the first system to the second system comprises transmitting the data attribute in accordance with a selected data attribute display format.

7. The method of claim 1, wherein transmitting a data attribute associated with the data string from the first system to the second system comprises transmitting the data attribute in accordance with a selected data attribute communication format.

8. The method of claim 1, wherein transmitting a data attribute associated with the data string from the first system to the second system comprises transmitting the data attribute from the first system to the second system via the Internet.

9. The method of claim 1, further comprising providing an integrated device, the integrated device being an integration of the first and second systems.

10. The method of claim 1, wherein receiving a first digital signature comprises receiving the first digital signature via a first communication channel between the first system and the second system, and wherein transmitting a data attribute comprises transmitting the data attribute via a second communication channel between the first system and the second system, and wherein transmitting first system authentication data comprises transmitting the first system authentication data via the second communication channel.

11. The method of claim 1, wherein the first system is a first device communicatively coupled to a network and the second system is a second device communicatively coupled to the network.

12. The method of claim 1, further comprising transmitting a data attribute associated with the data string from the first system to the second system in an automated agent identification challenge format.

13. A computer readable medium for storing a computer executable program for transmitting a data attribute associated with a data string from an authenticated system comprising:
computer readable code for providing a database operable to store at least one digital signature, the database being communicatively coupled to a first system;
computer readable code for receiving a first digital signature associated with a data string from a second system at the first system;
computer readable code for determining whether the first digital signature matches one of the at least one digital signatures;
computer readable code for transmitting a data attribute associated with the data string from the first system to the second system based on the determination; and
computer readable code for transmitting first system authentication data from the first system to the second system.

14. The computer readable medium of claim 13, wherein the computer readable code for transmitting first system authentication data from the first system to the second system comprises computer readable code for transmitting first system authentication data selected from a group consisting of a personal identification number, a pre-defined keyword, a pre-defined phrase, an anti-phishing image, a pre-defined display configuration, a date-time stamp, an first system public key or public key infrastructure digital signature.

15. The computer readable medium of claim 13, wherein the computer readable code for transmitting a data attribute associated with the data string comprises computer readable code for transmitting a data attribute selected from a group consisting of data whitelisted, data blacklisted, data stability, data functionality, data compatibility, and data value.

16. The computer readable medium of claim 13, wherein the computer readable code for providing a database operable to store at least one digital signature comprises computer readable code for providing a database operable to store at least one digital signature selected from a group consisting of a digital signature of whitelisted datastring, a digital signature of blacklisted datastring, and a hash value of the data string.

17. The computer readable medium of claim 13, wherein the computer readable code for receiving a first digital signature of a data string from a second system at the first system comprises computer readable code for receiving a hash value of the data string from the second system at the first system.

18. The computer readable medium of claim 13, wherein the computer readable code for transmitting a data attribute associated with the data string from the first system to the second system comprises computer readable code for transmitting the data attribute in accordance with a selected data attribute display format.

19. The computer readable medium of claim 13, wherein the computer readable code for transmitting a data attribute associated with the data string from the first system to the second system comprises computer readable code for transmitting the data attribute in accordance with a selected data attribute communication format.

20. The computer readable medium of claim 13, wherein the computer readable code for transmitting a data attribute associated with the data string from the first system to the second system comprises computer readable code for transmitting the data attribute from the first system to the second system via the Internet.

21. The computer readable medium of claim 13, wherein the computer readable code for receiving a digital signature comprises computer readable code for receiving the digital signature via a first communication channel between the first system and the second system, wherein the computer readable code for transmitting a data attribute comprises computer readable code for transmitting the data attribute via a second communication channel between the first system and the second system, and wherein the computer readable code for transmitting first system authentication data comprises computer readable code for transmitting first system authentication data via the second communication channel.

22. The computer readable medium of claim 13, further comprising computer readable code for transmitting a data attribute associated with the data string from the first system to the second system in an automated agent identification challenge format.

23. A method of transmitting a data attribute associated with a data string, the method comprising:
providing a database operable to store at least one digital signature, the database being communicatively coupled to a first system;
receiving a first digital signature associated with a data string from a second system at the first system;
determining whether the first digital signature matches one of the at least one digital signatures; and
transmitting a data attribute associated with the data string from the first system to the second system in an automated agent identification challenge format based on the determination.

24. The method of claim 24, further comprising transmitting first system authentication data from the first system to the second system.

25. The method of claim 24, wherein transmitting first system authentication data from the first system to the second system comprises transmitting first system authentication data in an automated agent identification challenge format.

26. The method of claim 24, wherein transmitting a data attribute associated with the data string from the first system to the second system comprises transmitting the data attribute in an automated agent identification challenge format.

27. The method of claim 24, wherein transmitting a data attribute associated with the data string comprises transmitting a data attribute selected from a group consisting of data whitelisted, data blacklisted, data stability, data functionality, data compatibility, and data value.

28. The method of claim 24 wherein providing a database operable to store at least one digital signature comprises providing a database operable to store at least one digital signature selected from a group consisting of a digital signature of whitelisted datastring, a digital signature of blacklisted datastring, and a hash value of the data string.

29. The method of claim 24, wherein receiving a first digital signature of a data string from a second system at the first system comprises receiving a hash value of the data string from the second system at the first system.

30. The method of claim 24, wherein transmitting a data attribute associated with the data string from the first system to the second system comprises transmitting the data attribute in accordance with a selected data attribute display format.

31. The method of claim 24, wherein transmitting a data attribute associated with the data string from the first system to the second system comprises transmitting the data attribute in accordance with a selected data attribute communication format.

32. The method of claim 24, wherein transmitting a data attribute associated with the data string from the first system to the second system comprises transmitting the data attribute from the first system to the second system via the Internet.

33. The method of claim 24, further comprising providing an integrated system, the integrated system being an integration of the first and second systems.

34. The method of claim 24, wherein receiving a first digital signature comprises receiving the first digital signature via a first communication channel between the first system and the second system, and wherein transmitting a data attribute comprises transmitting the data attribute via a second communication channel between the first system and the second system, and wherein transmitting first system authentication data comprises transmitting the first system authentication data via the second communication channel.

35. The method of claim 24, wherein the first system is a first device communicatively coupled to a network and the second system is a second device communicatively coupled to the network.

36. A computer readable medium for storing a computer executable program for transmitting a data attribute associated with a data string comprising:
computer readable code for providing a database operable to store at least one digital signature, the database being communicatively coupled to a first system;
computer readable code for receiving a first digital signature associated with a data string from a second system at the first system;
computer readable code for determining whether the first digital signature matches one of the at least one digital signatures; and
computer readable code for transmitting a data attribute associated with the data string from the first system to the second system in an automated agent identification challenge format based on the determination.

37. The computer readable medium of claim 36, further comprising computer readable code for transmitting first system authentication data from the first system to the second system.

38. The computer readable medium of claim 37, wherein the computer readable code for transmitting first system authentication data from the first system to the second system comprises computer readable code for transmitting first system authentication data in an automated agent identification challenge format.

39. The computer readable medium of claim 36, wherein the computer readable code for transmitting a data attribute associated with the data string from the first system to the second system comprises computer readable code for transmitting the data attribute in an automated agent identification challenge format.

40. The computer readable medium of claim 36, wherein the computer readable code for transmitting a data attribute associated with the data string comprises computer readable code for transmitting a data attribute selected from a group consisting of data whitelisted, data blacklisted, data stability, data functionality, data compatibility, and data value.

41. The computer readable medium of claim 36 wherein the computer readable code for providing a database operable to store at least one digital signature comprises computer readable code for providing a database operable to store at least one digital signature selected from a group consisting of a digital signature of whitelisted datastring, a digital signature of blacklisted datastring, and a hash value of the data string.

42. The computer readable medium of claim 36, wherein the computer readable code for receiving a first digital signature of a data string from a second system at the first system comprises computer readable code for receiving a hash value of the data string from the second system at the first system.

43. The computer readable medium of claim 36, wherein the computer readable code for transmitting a data attribute associated with the data string from the first system to the second system comprises computer readable code for transmitting the data attribute in accordance with a selected data attribute display format.

44. The computer readable medium of claim 36, wherein the computer readable code for transmitting a data attribute associated with the data string from the first system to the second system comprises computer readable code for transmitting the data attribute in accordance with a selected data attribute communication format.

45. The computer readable medium of claim 36, wherein the computer readable code for transmitting a data attribute associated with the data string from the first system to the second system comprises computer readable code for transmitting the data attribute from the first system to the second system via the Internet.

46. The computer readable medium of claim 36, wherein the computer readable code for receiving a first digital signature comprises computer readable code for receiving the first digital signature via a first communication channel between the first system and the second system, and wherein the computer readable code for transmitting a data attribute comprises computer readable code for transmitting the data attribute via a second communication channel between the first system and the second system, and wherein the computer readable code for transmitting first system authentication data comprises computer readable code for transmitting the first system authentication data via the second communication channel.

47. A method of transmitting a data attribute associated with a data string from an authenticated system, the method comprising:
providing a database operable to store at least one digital signature, the first database being communicatively coupled to a first system;
receiving a first digital signature of a data string from a second system at the first system;
determining whether the first digital signature matches one of the at least one digital signatures;
transmitting a data attribute associated with the data string from the first system to a third system based on the determination; and
transmitting first system authentication data from the first system to the third system.

48. The method of claim 47, further comprising establishing a communication channel between the first system and the third system using a communication system selected from a group consisting of a telephone communication system, a cellular telephone communication system, and a facsimile communication system.

49. The method of claim 47, wherein transmitting a data attribute associated with the data string comprises transmitting a data attribute selected from a group consisting of data whitelisted, data blacklisted, data stability, data functionality, data compatibility, and data value.

50. The method of claim 47, wherein providing a database operable to store at least one digital signature comprises providing a database operable to store at least one digital signature selected from a group consisting of a digital signature of whitelisted datastring, a digital signature of blacklisted datastring, and a hash value of the data string.

51. The method of claim 47, wherein receiving a first digital signature of a data string from a second system at the first system comprises receiving a hash value of the data string from the second system at the first system.

52. A computer readable medium for storing a computer executable program for transmitting a data attribute associated with a data string from an authenticated system comprising:
computer readable code for providing a database operable to store at least one digital signature, the database being communicatively coupled to a first system;
computer readable code for receiving a first digital signature of a data string from a second system at the first system;
computer readable code for determining whether the first digital signature matches one of the at least one digital signatures;
computer readable code for transmitting a data attribute associated with the data string from the first system to a third system based on the determination; and
computer readable code for transmitting first system authentication data from the first system to the third system.

53. The computer readable medium of claim 52, further comprising computer readable code for establishing a communication channel between the first system and the third system using a communication system selected from a group consisting of a telephone communication system, a cellular telephone communication system, and a facsimile communication system.

54. The computer readable medium of claim 52, wherein the computer readable code for providing a database operable to store at least one digital signature comprises computer readable code for providing a database operable to store at least one digital signature selected from a group consisting of a digital signature of whitelisted datastring, a digital signature of blacklisted datastring, and a hash value of the data string.

55. The computer readable medium of claim 52, wherein the computer readable code for providing a database operable to store at least one digital signature comprises computer readable code for providing a database operable to store at least one digital signature selected from a group consisting of a whitelist digital signature, a blacklist digital signature, a hash value of the data string, and a hash value of a corrupted version of the data string.

56. The computer readable medium of claim 52, wherein the computer readable code for receiving a first digital signature of a data string from a second system at the first system comprises computer readable code for receiving a hash value of the data string from the second system at the first system.
